(19) United States
(12) Patent Application Publication
(10) Pub. No.: US 2008/0195642 A1
(43) Pub. Date: Aug. 14, 2008

(54) Knowledge management and result generation system where items are electronically presentable work and knowledge elements or their references, its application method for producing other work or knowledge elements, and the method of delivering knowledge or work results using such elements.

(76) Inventor: Igor Voln, Honolulu, HI (US)

Correspondence Address: IGOR VOLN, 2464 PRINCE EDWARD ST. APT.1017, HONOLULU, CA, 96815, US

(21) Appl. No.: 11/674,926

(22) Filed: Feb. 14, 2007

(51) Int. Cl. G06F 17/30

(52) U.S. Cl. 707/101

(57) ABSTRACT

A computer based knowledge management and result generation system that uses electronically presentable work and knowledge items or their references, and the method of its usage for producing other work or knowledge items is presented as well as the method of delivering knowledge or work results using such items. The items are stored in knowledge bases. Each item could be elementary or refer to other items. The items are shareable, and users can add new items or improve existing items over time. If a work item is applied to some complex system and then its version in the knowledge base is improved, the system that uses the item can use the improved version. This can happen either automatically, or by subscription to the item changes, or manually. At the time of knowledge base application, the items can be used as simple constructive blocks or applied to some target entity. Items can be parameterized. At the time of item application, parameter values can be received from the user or derived from the target entity.

The author is successfully applying this system and methods to the software development process. In this case, the work and knowledge items are composite objects, containing code snippets or references to pre-developed modules, and logically related instructions.

The method of work delivery in the form of reusable system items significantly improves the design, modularity, and reusability of the items, even though it might require more advanced technical skills and longer time to create them. It results into accumulating modular reusable work items and the related knowledge for their future reuse.

### TECHNICAL FIELD OF THE INVENTION

This invention relates in general to the field of managing and applying knowledge and work items, and more particularly to knowledge and work items that can be recorded or referenced electronically. An example is described that applies the system and the methods to the field of software development; however, they could also be applied to other areas.

### BACKGROUND OF THE INVENTION

In our complex world, developing any more or less complex system is a task that involves many people and many hours of work for each person. Many separate results of work of many people need to be properly organized and applied. Gathering, accessing, applying, and preserving the knowledge and elements of work for future use become an important and critical task.

Many people use information or knowledge as part of their function within a business or other organization. These knowledge workers acquire information from multiple sources and use the acquired information with respect to some business or other suitable activity to generate value for the organization or users.

For example, in case of information technology projects, each worker learns how to perform a specific task and produces the code that will perform the necessary function or performs actions required to use a particular system. However, this knowledge or work is usually not shared in any way that can be effectively reused in the future, and could be lost at least partially due to different reasons or simply forgotten. One of the examples is when a knowledge worker leaves the organization. The knowledge needs to be gathered one more time, and the work needs to be done again.

### DESCRIPTION OF THE PRIOR ART

As available information sources become larger and more complex to serve a variety of knowledge workers with particular information needs, gathering, sharing, preserving, organizing, managing, locating, improving, and using information become increasingly important to the success of the organization. Existing systems have been inadequate to meet such needs, because they do not provide for effective ways of performing these tasks. Besides, prior systems do not adequately support the growth and perfection of the intellectual capital.

In the computer industry, the need to quickly find the right knowledge or an example of elementary work item gave birth to multiple computer based knowledge management systems, such as: help applications, support, online forums and discussions, web sites with F.A.Q. and examples. However, as the amount of information is huge and keeps growing, the search for the right item takes more and more time. Furthermore, the discovered information is not ready to use, frequently has mistakes, and each user has to go through the same process of searching, analyzing the suitability of the information, correcting the mistakes, and customizing for a particular case again and again. This is apparently inefficient, error prone, time consuming, and disadvantageous in many other ways. In terms of producing work results, one of the most unfortunate features of current systems is that each time a new project is started little or none of the previously performed work items are used, mostly because they are hard wired into the previous systems and extracting them would probably be more difficult than developing new versions. There are many systems that implement wizards, which walk the user through a set of steps to achieve a result. However, little or no provision is made for accumulating and extending such wizards, creating a corresponding improvable knowledge base, and making it widely usable by different users and from different environments.

### SUMMARY OF THE INVENTION

The purpose of the invention is creating of a system and methods of its use where the disadvantages and problems associated with the known systems are substantially reduced or eliminated.

According to the present invention, work or knowledge items or their references are stored in a shareable searchable computer-based knowledge management system. When a user needs to perform work, the user searches the system for appropriate items. If they are discovered and ready to use in this particular situation, the user applies them. If they are discovered but not ready to use, the user performs some additional work to improve the items to be able to handle such cases in the future. Thus, the elements of work and knowledge do not need to be recreated every time. They can be added or improved by users over time. Due to such accumulation, users will always get the latest and greatest information and work items at the time of the request.

Stored items are composites, i.e. an item can include references to other items or be referenced from other items. Thus, complex items can be built from simple items without storing the simple items multiple times. It preserves storage space. If an item is improved, all complex items that use it could inherit the improvements.

The main idea is to merge the knowledge base management logic with builders of work results so that locating the right item in a knowledge base is practically equivalent to getting the work done, bypassing the research and learning of the subject and reusing the work that has already been done instead of doing it again. Of course, in case there is no such item, a new work item needs to be created.

### BRIEF DESCRIPTION OF THE DRAWINGS

FIG. 1 is an example of different types of items stored in one of the knowledge bases of a system implementation.

FIG. 2 is an overview of technical design diagram of a system implementation.

FIG. 3 is an example of item verification and the corresponding user interface.

FIG. 4 is an example of applying of a work item.

FIG. 5 is an example of applying of a parameterized work item to a target entity.

FIG. 6 is an example of loading of a work item into a partial application controller (tree)

FIG. 7 is the result of applying of the work item from FIG. 5

FIG. 8 is an example of marking of an applied item.

### DETAILED DESCRIPTION OF THE INVENTION

To provide for the best usability, knowledge base items are logically subdivided into the following parts:
Work items, which include the pre-developed pieces of work (code fragments, documents, references to material or non-material items, and description of their application)
Knowledge items, which include the pre-developed pieces of knowledge (step-by-step guides to achieve a particular purpose or use a work item, descriptions of material or non-material items).
   For convenience, these parts will further be referred to as the knowledge base items (KBI).

According to one embodiment of the present invention, the system is comprised of multiple data repositories that contain KBI filled searchable knowledge bases. For convenience of use and manipulation the KBIs are grouped based on the area of use (for example, C Sharp code, Java code, Cooking recipes, Supplements, Images etc). Every KBI has a unique worldwide identifier and conforms to a common world wide standard, which provides for easy merging or linking of knowledge bases. KBIs are composites, i.e. an item can include references to other items or be referenced from other items. KBIs are created in the way they can be used as is or with minor modifications. KBIs could have further enforceable restrictions (for example, code snippets could be checked for compliance with a code grammar)

A user is either a person or a process. KBIs are accessible to one or many users. Users can perform operations based on their user rights. Users can improve existing KBIs and create new ones as well as improve relationships among them.

The users and controllers of the system can make the following KBI adjustments:

Verification, fixing problems, correcting comments.

Tuning, improving performance and other characteristics.

Improving reusability.

Editing information for easier comprehension or extension

Adding versions customized for specific uses.

Assigning ratings that can be used for improving searches

Collecting data on frequency of usage

At the time the information is requested the system delivers the most recent information for each KBI. An arrangement is made to be able to update the KBI items that have already been applied with their updated versions from the knowledge base. To achieve this, items could be used by reference, or users have the option to subscribe for the KBI updates. Both automatic and user initiated replacements are supported.

KBIs can have parameters. At the time of KBI application, parameter values can be received from the user, derived from the target entity to which the item is applied, or taken from the default values.

The KBIs in knowledge bases improve over time which constitutes the evolution of the knowledge. Thus, the items are not only preserved but also further developed and perfected; it can considerably increase the value and the usability of these knowledge bases. It can also be easily determined what work items have already been completed and the work won't need to be re-done again. Evolutionary structure of the system guarantees that the system always provides the best and most complete results according to current state of knowledge. Besides that, the system is definitely an invaluable educational resource for business newcomers.

The invention also includes the method where work items are developed as a set of KBI items and then applied using the system to obtain the results. In this case, the items are automatically added to knowledge bases and become reusable. Besides, they are verified during the first application. This method facilitates system development process and improves work item modularity and reusability.

A few provisions are made to make the knowledge base searches more effective. For example, items with low ratings are not returned or shown at the end of search results. Frequency of usage is counted and search quality is improved based on the frequency of use. A list of the most recently used KBIs is maintained. To facilitate searches, KBIs are categorized and marked with keywords. An item can be uncategorized or contained in a few categories.

The system could have additional controllers that could let users apply work items partially based on some criteria.

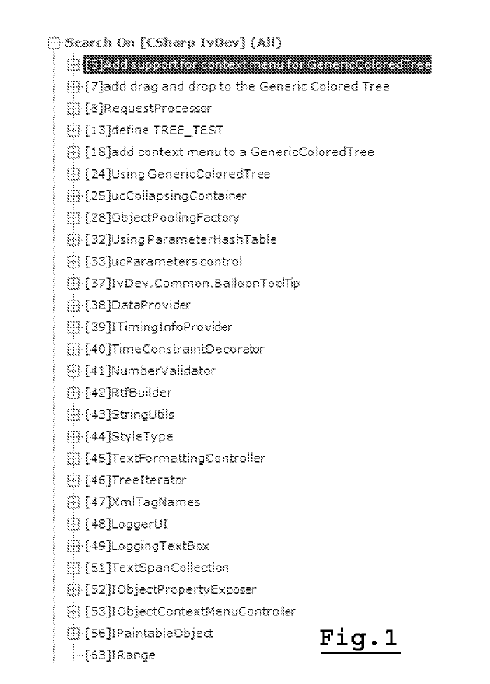

FIG. 1 shows a subset of items stored in the repository called “CSharp IvDev”. It contains all types of items. For example, the item “RequestProcessor” contains the code of a reusable class and, therefore, it is a pre-developed work item. The item “ucCollapsingContainer” is a reference to a reusable work item, which is a set of files stored in some place on a hard drive. “DataProvider” is a knowledge item, because it only contains instructions about using a particular class. Some items have mixed content, i.e. contain a mix of work items, references, and knowledge items.

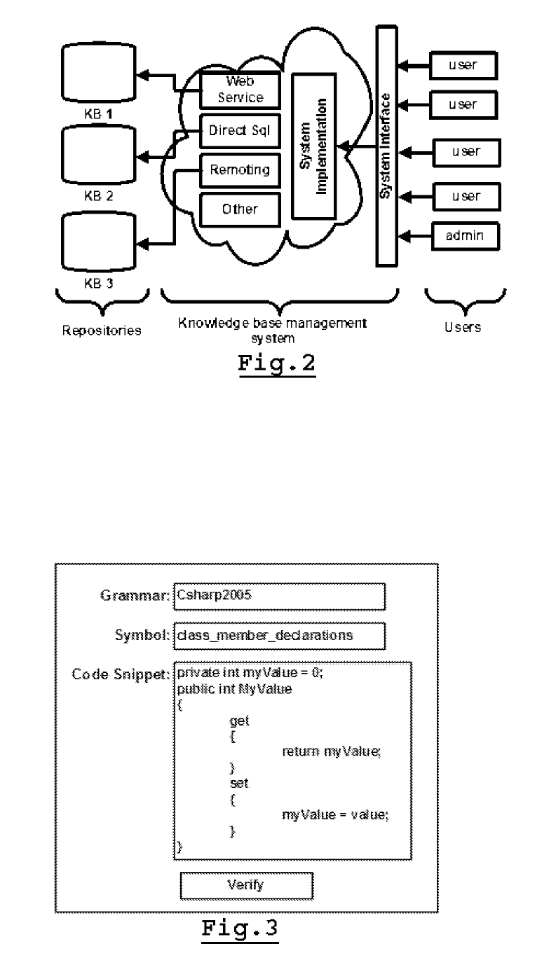

FIG. 2 is an overview of a system implementation diagram. Users access knowledge base items (KBIs) stored in a set of knowledge bases using the knowledge management system.

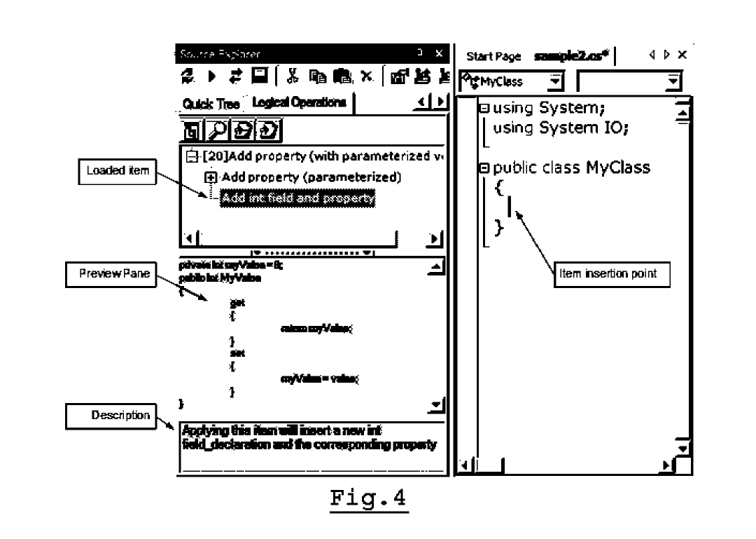

FIG. 3 is an example of work item verification when the work item is a code snippet. A user enters the code snippet as well as its grammar name and symbol, and presses “Verify” to verify the validity of the entered snippet. The verification in this case is the parsing of the code snippet using the specified grammar and symbol. The described embodiment also has a set of processes that run verification on a subset of the knowledge items to determine whether the items in the subset are valid.

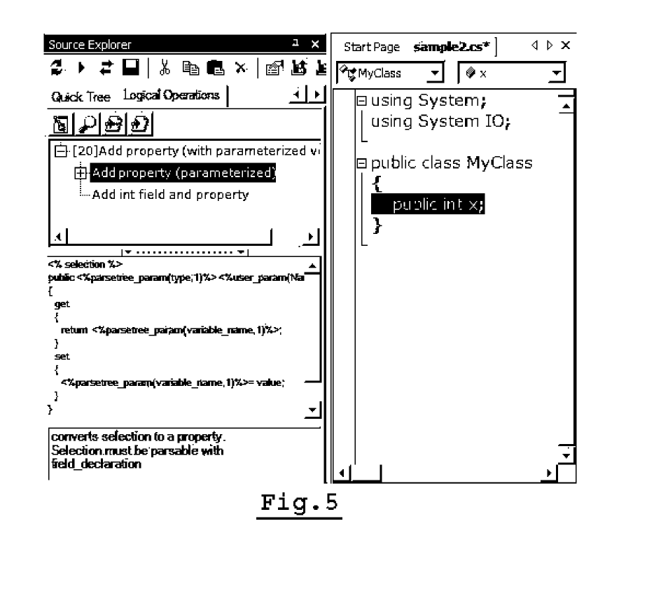

FIG. 4 is an example of applying a work item. In this case, the work item is a code snippet (see the preview pane) and a user is working on developing a code module (file “sample2.cs” in the right pane). User moves the cursor to some target location inside the code file (the insertion point) and commands to insert the code snippet. In terms of the described invention, it is applying a work item to get work results.

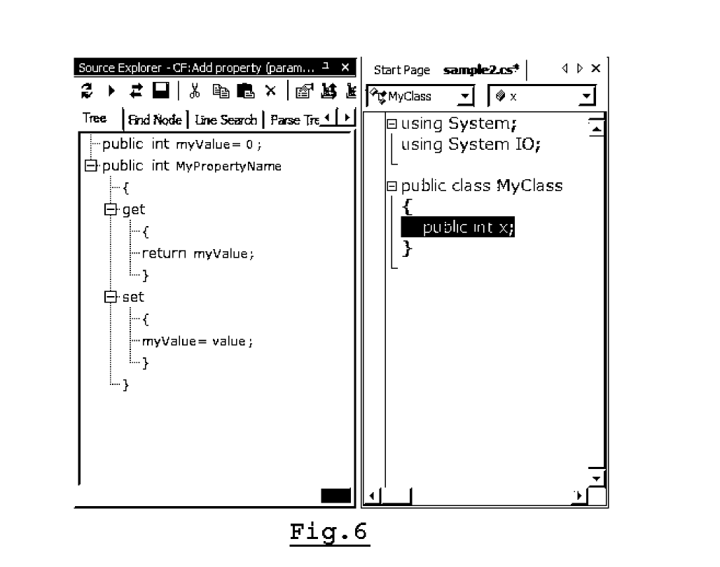

FIG. 4 is a simplified example. FIG. 5 is a more complicated example, because in this case there is a target entity (text selection in the right pane) and a user parameter. When a user applies this work item, first, a dialog is presented, asking to enter the user parameter (in the shown case, the name of the property that will be created). Then, the target entity (i.e. text selection) is used to adjust the work item to fit the concrete needs (i.e. the selection is parsed to determine the type of the variable, which will then be used as the type of the property; in the shown case, it is an integer)

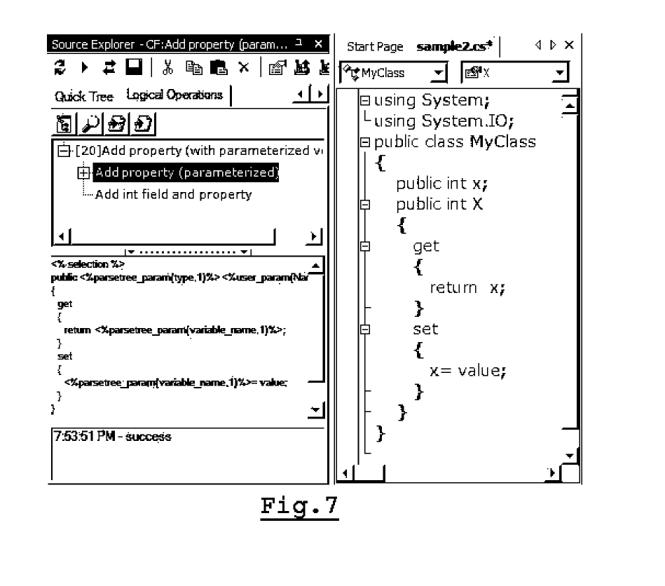

FIG. 6 shows an example of a partial application controller. Namely, the code snippet is loaded into a representation tree (see United States Patent Application 20050256891). The tree is a multi-select tree so that the user can select only a subset of the tree nodes and command to apply only them. In the described embodiment, it is done using drag-and-drop of the required nodes to the developed document (file “sample2.cs”)

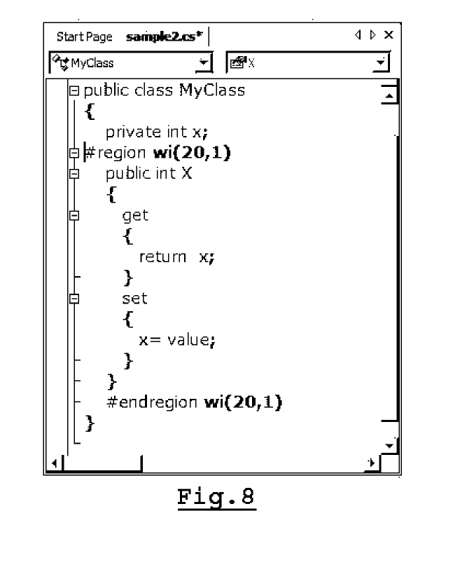

FIG. 7 is the result of applying of the work item from FIG. 5

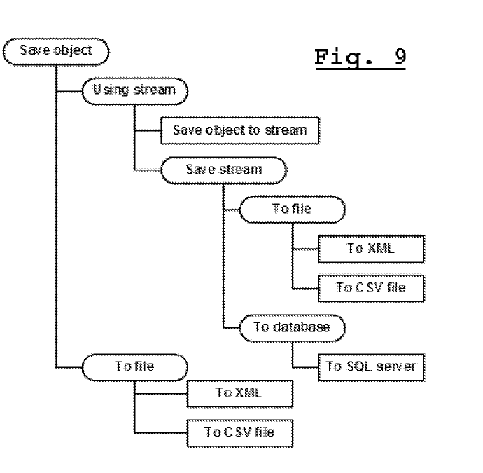

FIG. 8 is an example of marking of an applied item in the target entity. It can be used to follow up in case the work item in the knowledge base changes. Searching for a special tag with the work item id, a user or a process can easily locate the applied item and replace it with its updated version.

FIG. 9 can be used as a demonstration of the evolution of an item. For example, let's assume that a user 1 once needed to save an object to a file in the “comma separated values” (CSV) format. User 1 performed a search in the knowledge base and could not find any appropriate snippet of code. User 1 then created the item “Save Object”, sub item “To File”, and sub item “To CSV” which contained the code to save an object as a CSV file. Some time later, another user, User 2, needed to store an object to Xml. User 2 found the item, created by User 1, and added the item “To Xml” which contained the code to save an object to Xml. As time passed, different users kept reusing, improving, and extending the described item. FIG. 9 presents the result of such item evolution at a point of time. Rounded rectangles represent container items, while regular rectangles represent items with no children.

This approach in the described embodiment compliments the Rapid Application Development (“RAD”) methodology.

Obviously many modifications and variations of the present invention are possible. It is intended to cover in the appended claims all such modifications as fall within the true spirit and scope of the invention.

What is claimed is:

1. A computer-based searchable knowledge management system where knowledge base items are electronic work pieces, their references, or action descriptions suitable for creating complex systems or performing complex tasks. Items are stored in knowledge bases. Logically related knowledge bases are grouped in repositories. The format for the stored items is open and standardized, so that items can be moved from storage to storage and used by the systems created by different organizations. Knowledge bases could be merged or linked if needed. The stored items could be elementary or refer to other items. The items are shareable. The items or relationships among them could be improved over time either by users or by special controllers. A user could be defined as a person or a process. Items could be globally identified using a unique identifier.

2. The system described in claim 1, where item improvements include all changes suitable for performing the final work result in a better fashion, such as verification and fixing problems, correcting descriptions, improving performance, rearranging, adding items that are customized for specific tasks, ratings, frequency usage data, etc.

3. The system described in claim 1, where if a work item is applied to some complex system and then its version in the knowledge base is improved, the system that uses the item could use the improved version. This could happen either automatically, or by some kind of subscription to the item changes, or manually.

4. The system described in claim 1, where the knowledge base items are parameterized. At the time of application, parameter values can be received from the user, derived from the target entity to which the item is applied, or taken from default values.

5. The system described in claim 1, where search quality is improved using commonly known methods such as item ratings, frequency of usage, keywords, etc.

6. The system described in claim 1, where the users can only perform the actions allowed by their assigned rights or roles.

7. The system described in claim 1, where the items are categorized. Categories can help to locate items in searches or via category browsing. An item can appear in more than one category. Categories only keep references to stored items to preserve storage space.

8. The method of using the system described in claim 1 where a specialized application assists the user in applying the knowledge items to create composite work results. An item could be applied as a whole or partially.

9. The method of work delivery, when the work items are delivered or recorded in the format described in claim 1, which improves their design, modularity, and reusability for future use.
